(19) United States
(12) Patent Application Publication
(10) Pub. No.: US 2003/0133565 A1
(43) Pub. Date: Jul. 17, 2003

(54) Echo cancellation system method and apparatus

(76) Inventors: Chienchung Chang, Santa Fe, CA (US); Narendranath Malayath, San Diego, CA (US)

Correspondence Address: QUALCOMM Incorporated, Attn: Patent Department, 5777 Morehouse Drive, San Diego, CA, 92121-1714, US

(21) Appl. No.: 10/050,377

(22) Filed: Jan. 15, 2002

(51) Int. Cl. H04M 9/08; H04M 7/00

(52) U.S. Cl. 379/406.01; 379/417

(57) ABSTRACT

An improved echo cancellation system (400) includes a double talk detector (406) configured for detecting a double talk condition by monitoring voice energy in a first frequency band (503). An adaptive filter (420) is configured for producing an echo signal based on a set of coefficients, and holds the set of coefficients constant when the double talk detector (406) detects the double talk condition. A microphone system (402) inputs audible signals (404) in a second frequency band (520) that is wider and overlaps the first frequency band (503). The echo signal is used to cancel echo in the input signal. A loud speaker (401) is configured for playing voice data in a third frequency band (501) essentially equal to a difference of the first and second frequency bands (502 and 503). The first and third frequency bands (503 and 501) essentially makeup the second frequency band (502).

### BACKGROUND

1. Field of the Invention

The disclosed embodiments relate to the field of echo cancellation system, and more particularly, to echo cancellation in a communication system.

2. Background

Echo cancellation is generally known. Acoustic echo cancellers are used to eliminate the effects of acoustic feedback from a loudspeaker to a microphone. Generally, a device may have both a microphone and a speaker. The location of the microphone may be close to the speaker such that the audio from the speaker may reach the microphone at sufficient level. When the feedback from the speaker to the microphone is not cancelled through an echo cancellation process, the far end user that produced the audio in the speaker may hear its own speech in a form of echo. The near end user may also speak into the microphone while the far end user speech is being played by the speaker. As a result, the far end user may hear its own echo and the near end user speech at the same time. In such a situation, the far end user may have difficulty hearing the near end user. The impact of echo is especially annoying during conversation. An echo canceller may be used by the near end user device to cancel the echo of the far end user before any audio generated by the near end user microphone is transmitted to the far end user. However, it is difficult to cancel the echo in the audio frequency band when the near end user speech is also in the audio frequency band.

A block diagram of a traditional echo canceller 199 is illustrated in FIG. 1. The far-end speech f(t) from a speaker 121 may traverse through an unknown acoustic echo channel 120 to produce the echo e(t). The echo e(t) may be combined with the near-end speech n(t) to form the input (n(t)+e(t)) 129 to the microphone 128. The effect of acoustic echo depends mainly on the characteristics of acoustic echo channel 120. Traditionally, an adaptive filter 124 is used to mimic the characteristics of the acoustic echo channel 120 as shown in FIG. 1. The adaptive filter 124 is usually in the form of a finite impulse response (FIR) digital filter. The number of taps of the adaptive filter 124 depends on the delay of echo that is attempted to be eliminated. The delay is proportional to the distance between the microphone and the speaker and processing of the input audio. For instance, in a device with microphone and speaker mounted in close proximity, the number of taps may be smaller than 256 taps if the echo cancellation is performed in 8 KHz pulse code modulation (PCM) domain.

In a hands-free environment, an external speaker may be used. The external speaker and the microphone are usually set far apart, resulting in a longer delay of the echo. In such a case, the adaptive filter 124 may require 512 taps to keep track of the acoustic echo channel 120. The adaptive filter 124 may be used to learn the acoustic echo channel 120 to produce an echo error signal e1(n). The error signal e1(n) is in general a delayed version of far end speech f(t). The input audio picked up by the microphone 128 is passed through an analog to digital converter (ADC) 127. The ADC process may be performed with a limited bandwidth, for example 8 kHz. The digital input signal S(n) is produced. A summer 126 subtracts the echo error signal e1(n) from the input signal S(n) to produce the echo free input signal d(n). When the adaptive filter 124 operates to produce a matched acoustic echo channel, the estimated echo error signal e1(n) is equal to the real echo produced in the acoustic echo channel 120, thus:

d(n)=s(n)−e1(n)=[n(n)+e(n)]−e1(n)=n(n)

where n(n) and e(n) are discrete-time version of n(t) and e(t) respectively after 8 KHz ADC. A voice decoder 123 may produce the far end speech signal f(n) and passed on to an ADC 122 to produce the signal f(t). Moreover, the signal d(n) is also passed on to a voice encoder 125 for transmission to the far end user.

A gradient descent or least mean square (LMS) error algorithm may be used to adapt the filter tap coefficients from time to time. When only the far-end speaker is speaking, the adaptive filter attempts to gradually learn the acoustic echo channel 120. The speed of the learning process depends upon the convergence speed of algorithm. However, when the near-end speaker is also speaking, the adaptive filter 124 holds its tap coefficients constant since the adaptive filter 124 needs to determine the coefficients based on the far-end speech. When the adaptive filter 124 adjusts its tap coefficients while the near end speech n(n) exists, the adaptation is based on the near end speech, which is the form of: d(n)=n(n)+[e(n)−e1(n)], instead of the signal in the form of: d(n)=e(n)−e1(n). Therefore, if the filter adaptation is allowed while the near-end speech exists, the filter coefficients may diverge from an ideal acoustic echo channel estimate. One of the most difficult problems in echo cancellation is for the adaptive filter 124 to determine when it should adapt and when it should stop adapting. It is difficult to discern whether the input audio is a loud echo or a soft near-end speech. Normally, when the speaker is playing the far end user speech and the near end user is speaking, a double talk condition exists. A condition of double talk detection is achieved by comparing the echo return loss enhancement (ERLE) to a preset threshold. ERLE is defined as the ratio of echo signal energy (σₑ²) and the error signal energy (σ_{d}²) in dB:

$$ERLE = \text{10} log ( \frac{{σ}_{e}^{2}}{{σ}_{d}^{2}} )$$

The echo and error signal energy is estimated based on short-term frame energy of e(n) and d(n). ERLE reflects the degree for which the acoustic echo is canceled and how effective the echo canceller cancels the echo. When double talk occurs, ERLE becomes small in dB since the near end speech exists in d(n). A traditional double talk detector may be based on the value of ERLE. If ERLE is below a preset threshold, a double talk condition is declared.

However, the double talk detection based on ERLE has many drawbacks. For instance, ERLE can change dramatically when the acoustic echo channel changes from time to time. For example, the microphone may be moving, thus creating a dynamic acoustic echo channel. In a dynamic acoustic echo channel, the adaptive filter124 may keep adapting based on ERLE values that are not reliable enough to determine a double talk condition. Moreover, adapting based on ERLE provides a slow convergence speed of the adaptive filter 124 in a noisy environment.

Furthermore, the near end user device may utilize a voice recognition VR system. The audio response of the near end user needs to be recognized in the VR system for an effective VR operation. When the audio response is mixed with echo of the far end user, the audio response of the near end user may not be recognized very easy. Moreover, the audio response of the near end user may be in response to a voice prompt. The voice prompt may be generated by the VR system, voice mail (answering machine) system or other well-known human machine interaction processes. The voice prompt, played by the speaker 121, also may be echoed in the voice data generated by the microphone 128. The VR system may get confused by detecting the echo in signal d(n) as the voice response of the near end user. The VR system needs to operate on the voice response from the near end user.

Therefore, there is a need for an improved echo cancellation system.

### SUMMARY

Generally stated, a method and an accompanying apparatus provides for an improved echo cancellation system. The system includes a double talk detector configured for detecting a double talk condition by monitoring voice energy in a first frequency band. An adaptive filter is configured for producing an echo signal based on a set of coefficients. The adaptive filter holds the set of coefficients constant when the double talk detector detects the double talk condition. A microphone system is configured for inputting audible signals in a second frequency band. The second frequency band is wider and overlaps the first frequency band and the echo signal is used to cancel echo in the input signal. A loud speaker is configured for playing voice data in a third frequency band essentially equal to a difference of the first and second frequency bands. The first and third frequency bands essentially makeup the second frequency band. A control signal controls the adaptive filter, to hold the set of coefficients constant, based on whether the double talk detector detects the double talk condition.

### BRIEF DESCRIPTION OF THE DRAWINGS

The features, objects, and advantages of the disclosed embodiments will become more apparent from the detailed description set forth below when taken in conjunction with the drawings in which like reference characters identify correspondingly throughout and wherein:

FIG. 1 illustrates a block diagram of an echo canceller system;

FIG. 2 illustrate partitioning of a voice recognition functionality between two partitioned sections such as a front-end section and a back-end section;

FIG. 3 depicts a block diagram of a communication system incorporating various aspects of the disclosed embodiments.

FIG. 4 illustrates partitioning of a voice recognition system in accordance with a co-located voice recognition system and a distributed voice recognition system;

FIG. 5 illustrates various blocks of an echo cancellation system in accordance with various aspects of the invention; and

FIG. 6 illustrates various frequency bands used for sampling the input voice data and the limited band of the speaker frequency response in accordance with various aspects of the invention.

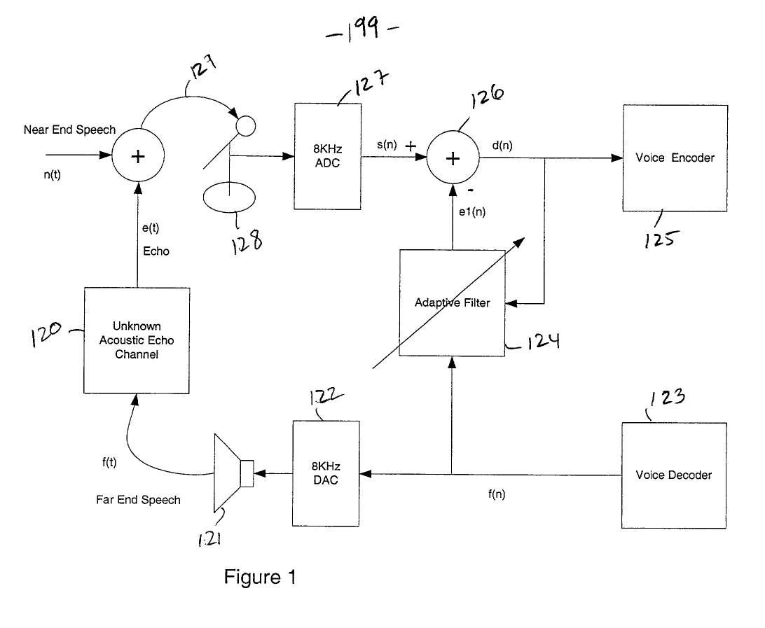

### DETAILED DESCRIPTION OF THE PREFERRED EMBODIMENT

Generally stated, a novel and improved method and apparatus provide for an improved echo cancellation system. The echo cancellation system may limit the output frequency band of the speaker of the device. The output of the microphone of the device is expanded to include a frequency band larger than the limited frequency band of the speaker. An enhanced double talk detector detects the signal energy in a frequency band that is equal to the difference of the limited frequency band of the speaker and the expanded frequency band of the microphone. The adaptation of an adaptive filter in the echo cancellation system is controlled in response to the double talk detection. The parameters of the adaptive filter are held at a set of steady values when a double talk condition is present. The near end user of the device may be in communication with a far end user.

The device used by the near end user may utilize a voice recognition (VR) technology that is generally known and has been used in many different devices. A VR system may operate in an interactive environment. In such a system, a near end user may respond with an audio response, such as voice audio, to an audio prompt, such as a voice prompt, from a device. The voice generated by the speaker of the device, therefore, may be a voice prompt in an interactive voice recognition system utilized by the device. The improved echo cancellation system removes the echo generated by the voice prompt when the near end user is providing a voice response while the voice prompt is being played by the speaker of the device. The device may be a remote device such as a cellular phone or any other similarly operated device. Therefore, the exemplary embodiments described herein are set forth in the context of a digital communication system. While use within this context is advantageous, different embodiments of the invention may be incorporated in different environments or configurations. In general, various systems described herein may be formed using software-controlled processors, integrated circuits, or discrete logic. The data, instructions, commands, information, signals, symbols, and chips that may be referenced throughout are advantageously represented by voltages, currents, electromagnetic waves, magnetic fields or particles, optical fields or particles, or a combination thereof. In addition, the blocks shown in each block diagram may represent hardware or method steps.

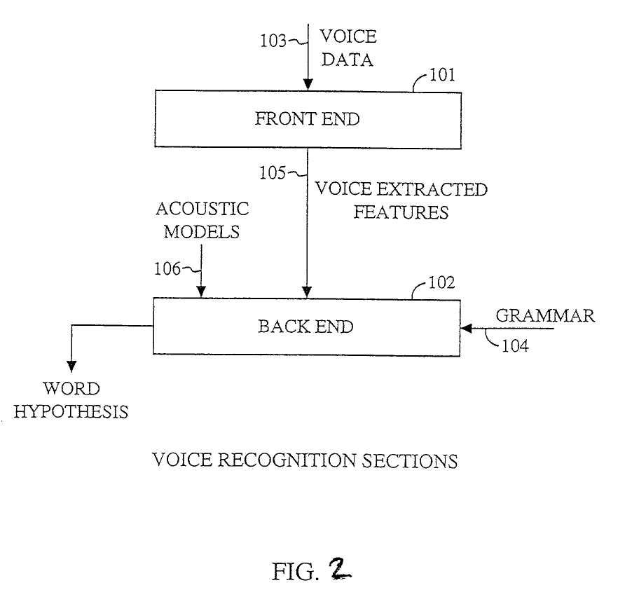

Referring to FIG. 2, generally, the functionality of VR may be performed by two partitioned sections such as a front-end section 101 and a back-end section 102. An input 103 at front-end section 101 receives voice data. The microphone 128 may originally generate the voice data. The microphone through its associated hardware and software converts the audible voice input information into voice data. The input voice data to the back end section 102 may be the voice data d(n) after the echo cancellation. Front-end section 101 examines the short-term spectral properties of the input voice data, and extracts certain front-end voice features, or front-end features, that are possibly recognizable by back-end section 102.

Back-end section 102 receives the extracted front-end features at an input 105, a set of grammar definitions at an input 104 and acoustic models at an input 106. Grammar input 104 provides information about a set of words and phrases in a format that may be used by back-end section 102 to create a set of hypotheses about recognition of one or more words. Acoustic models at input 106 provide information about certain acoustic models of the person speaking into the microphone. A training process normally creates the acoustic models. The user may have to speak several words or phrases for creating his or her acoustic models.

Generally, back-end section 102 compares the extracted front-end features with the information received at grammar input 104 to create a list of words with an associated probability. The associated probability indicates the probability that the input voice data contains a specific word. A controller (not shown), after receiving one or more hypotheses of words, selects one of the words, most likely the word with the highest associated probability, as the word contained in the input voice data. The system of back end 102 may reside in a microprocessor. The recognized word is processed as an input to the device to perform or respond in a manner consistent with the recognized word.

In the interactive VR environment, a near end user may provide a voice response to a voice prompt from the device. The voice prompt may or may not be generated by the VR system. The voice prompt from the device may last for a duration. While the voice prompt is playing, the user may provide the voice response. The microphone 128 picks up both the voice prompt and the voice response. As a result, the input voice data 103 is a combination of the voice prompt and the user voice response. As a result, the input voice data 103 may include a more complex set of voice features than the user voice input alone. When the user voice features are mixed with other voice features, the task of extracting the user voice features is more difficult. Therefore, it is desirable to have an improved echo cancellation system in an interactive VR system.

The remote device in the communication system may decide and control the portions of the VR processing that may take place at the remote device and the portions that may take place at a base station. The base station may be in wireless communication with the remote device. The portion of the VR processing taking place at the base station may be routed to a VR server connected to the base station. The remote device may be a cellular phone, a personal digital assistant (PDA) device, or any other device capable of having a wireless communication with a base station. The remote device may establish a wireless connection for communication of data between the remote device and the base station. The base station may be connected to a network. The remote device may have incorporated a commonly known micro-browser for browsing the Internet to receive or transmit data. The wireless connection may be used to receive front end configuration data. The front end configuration data corresponds to the type and design of the back end portion. The front end configuration data is used to configure the front portion to operate correspondingly with the back end portion. The remote device may request for the configuration data, and receive the configuration data in response. The configuration data indicates mainly filtering, audio processing, etc, required to be performed by the front end processing.

The remote device may perform a VR front-end processing on the received voice data to produce extracted voice features of the received voice data in accordance with a programmed configuration corresponding to the design of the back end portion. The remote device through its microphone receives the user voice data. The microphone coupled to the remote device takes the user input voice, and converts the input into voice data. After receiving the voice data, and after configuring the front end portion, certain voice features in accordance with the configuration are extracted. The extracted features are passed on to the back end portion for VR processing.

For example, the user voice data may include a command to find the weather condition in a known city, such as Boston. The display on the remote device through its micro-browser may show “Stock Quotes|Weather|Restaurants|Digit Dialing|Nametag Dialing|Edit Phonebook” as the available choices. The user interface logic in accordance with the content of the web browser allows the user to speak the key word “Weather”, or the user can highlight the choice “Weather” on the display by pressing a key. The remote device may be monitoring for user voice data and the keypad input data for commands to determine that the user has chosen “weather.” Once the device determines that the weather has been selected, it then prompts the user on the screen by showing “Which city?” or speaks “Which city?”. The user then responds by speaking or using keypad entry. The user may begin to speak the response while the prompt is being played. In such a situation, the input voice data, in addition to the user input voice data, includes voice data generated by the voice prompt, in a form of feed back to the microphone from the speaker of the device. If the user speaks “Boston, Mass.”, the remote device passes the user voice data to the VR processing section to interpret the input correctly as a name of a city. In return, the remote device connects the micro-browser to a weather server on the Internet. The remote device downloads the weather information onto the device, and displays the information on a screen of the device or returns the information via audible tones through the speaker of the remote device. To speak the weather condition, the remote device may use text-to-speech generation processing. The back end processings of the VR system may take place at the device or at VR server connected to the network.

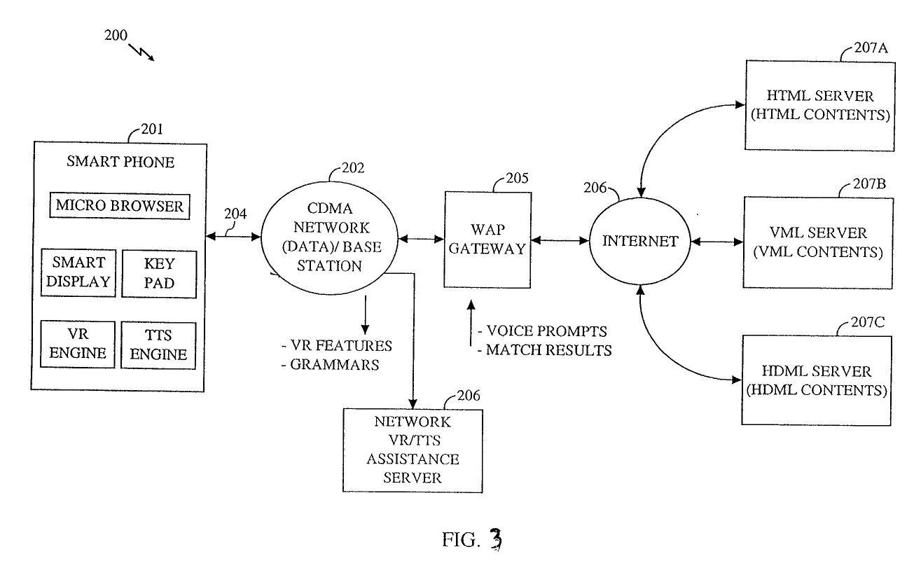

In one or more instances, the remote device may have the capacity to perform a portion of the back-end processing. The back end processing may also reside entirely on the remote device. Various aspects of the disclosed embodiments may be more apparent by referring to FIG. 3. FIG. 3 depicts a block diagram of a communication system 200. Communication system 200 may include many different remote devices, even though one remote device 201 is shown. Remote device 201 may be a cellular phone, a laptop computer, a PDA, etc. The communication system 200 may also have many base stations connected in a configuration to provide communication services to a large number of remote devices over a wide geographical area. At least one of the base stations, shown as base station 202, is adapted for wireless communication with the remote devices including remote device 201. A wireless communication link 204 is provided for communicating with the remote device 201. A wireless access protocol gateway 205 is in communication with base station 202 for directly receiving and transmitting content data to base station 202. The gateway 205 may, in the alternative, use other protocols that accomplish the same or similar functions. A file or a set of files may specify the visual display, speaker audio output, allowed keypad entries and allowed spoken commands (as a grammar). Based on the keypad entries and spoken commands, the remote device displays appropriate output and generates appropriate audio output. The content may be written in markup language commonly known as XML HTML or other variants. The content may drive an application on the remote device. In wireless web services, the content may be up-loaded or down-loaded onto the device, when the user accesses a web site with the appropriate Internet address. A network commonly known as Internet 206 provides a land-based link to a number of different servers 207A-C for communicating the content data. The wireless communication link 204 is used to communicate the data to the remote device 201.

In addition, in accordance with an embodiment, a network VR server 206 in communication with base station 202 directly may receive and transmit data exclusively related to VR processing. Server 206 may perform the back-end VR processing as requested by remote station 201. Server 206 may be a dedicated server to perform back-end VR processing. An application program user interface (API) provides an easy mechanism to enable applications for VR running on the remote device. Allowing back-end processing at the sever 206 as controlled by remote device 201 extends the capabilities of the VR API for being accurate, and performing complex grammars, larger vocabularies, and wide dialog functions. This may be accomplished by utilizing the technology and resources on the network as described in various embodiments.

A correction to a result of back end VR processing performed at VR server 206 may be performed by the remote device, and communicated quickly to advance the application of the content data. If the network, in the case of the cited example, returns “Bombay” as the selected city, the user may make correction by repeating the word “Boston.” The word “Bombay” may be in an audio response by the device. The user may speak the word “Boston” before the audio response by the device is completed. The input voice data in such a situation includes the names of two cities, which may be very confusing for the back end processing. However, the back end processing in this correction response may take place on the remote device without the help of the network. In alternative, the back end processing may be performed entirely on the remote device without the network involvement. For example, some commands (such as spoken command “STOP” or keypad entry “END”) may have their back end processing performed on the remote device. In this case, there is no need to use the network for the back end VR processing, therefore, the remote device performs the front end and back end VR processings. As a result, the front end and back end VR processings at various times during a session may be performed at a common location or distributed.

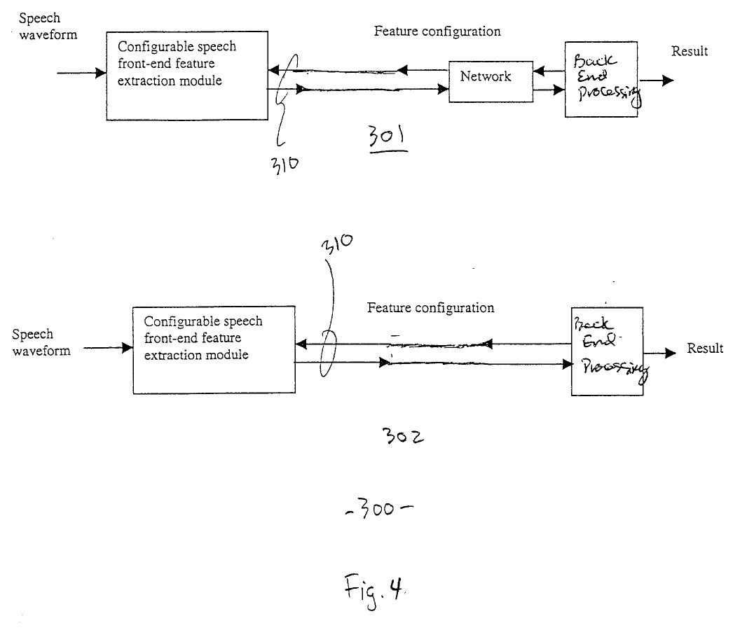

Referring to FIG. 4, a general flow of information between various functional blocks of a VR system 300 is shown. A distributed flow 301 may be used for the VR processing when the back end processing and front end processings are distributed. A co-located flow 302 may be used when the back end and front end processings are co-located. In the distributed flow 301, the front end may obtain a configuration file from the network. The content of the configuration file allows the front end to configure various internal functioning blocks to perform the front end feature extraction in accordance with the design of the back end processing. The co-located flow 302 may be used for obtaining the configuration file directly from the back end processing block. The communication link 310 may be used for passing the voice data information and associated responses. The co-located flow 302 and distributed flow 301 may be used by the same device at different times during a VR processing session.

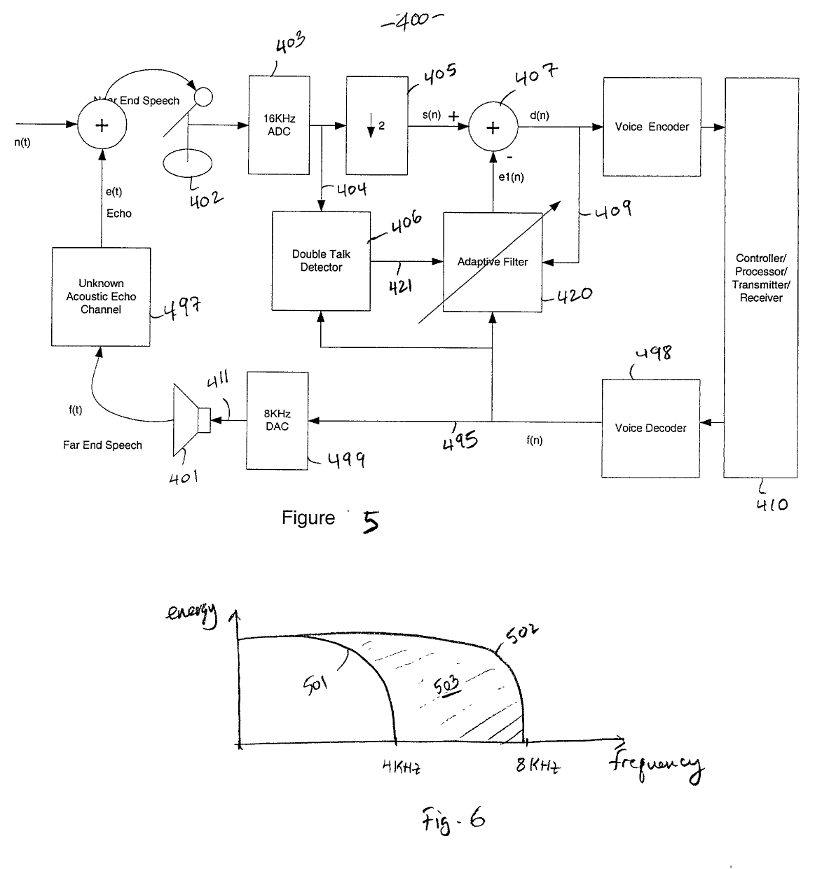

Referring to FIG. 5, various blocks of an enhanced echo cancellation system 400 is shown in accordance with various embodiments of the invention. A speaker 401 outputs the audio response of an audio signal 411. The bandwidth of the audio signal 411 is limited in accordance with various aspects of the invention. For example, the bandwidth may be limited to zero to 4 kHz. Such a bandwidth is sufficient for producing a quality audio response from the speaker 401 for human ears. The audio signal 411 may be generated from different sources. For example, the audio signal 411 may be originated from a far end user in communication with a near end user of the device or a voice prompt in an interactive VR system utilized by the device. The far end audio signal f(n) 495 in digital domain may be processed in an ADC 499 with a limited bandwidth in accordance with various aspects of the invention. The far end signal 411 with a limited bandwidth is produced. For example, if the sampling frequency of the ADC 499 is set to 8 kHz, the audio signal 411 may have a bandwidth of approximately 4 kHz. The signal f(n) 495 may have been received from a voice decoder 498. A unit 410 may produce the input to voice decoder 498 in a form of encoded and modulated signal. The unit 410 may include a controller, a processor, a transmitter and a receiver. The signal decoded by voice decoder 498 may be in a form of audio PCM samples. Normally, the PCM samples data rate is 8K samples per second in traditional digital communication systems. The audio PCM samples are converted to analog audio signal 411 via 8 KHz ADC 499 and the played by speaker 401. The produced audio, therefore, is band limited in accordance with various aspects of the invention.

The audio signal 411 also may have been produce by a voice prompt in a VR system. The unit 410 may also provide the data voice packets to the voice decoder 498. The audio signal 411 is then produced which carries the voice prompt. The data voice packets may be encoded off-line from band limited speech and thus can be used to reproduce the band limited voice prompts. The voice prompt may be generated by the network or by the device. The voice prompt may also be generated in relation to operation of an interactive VR system. The VR system in part or in whole may reside in the device or the network. Under any condition, the produced audio signal 411 is band limited in accordance with various aspects of the invention.

A microphone 402 picks up a combination of the audio response of the near end user and the audio from the speaker 401. The audio from the speaker 401 may pass through the acoustic echo channel 497. An ADC 403 converts the received audio to voice data 404. The voice response of the near end user includes various frequency components, for example from zero to 8 kHz. The sampling frequency of ADC 403 is selected such that the voice data 404 includes frequency components in a frequency band greater than the limited frequency band of audio signal 411 played by speaker 401, in accordance with various aspects of the invention. For example, a sampling frequency of 16 kHz may be selected. Therefore, the frequency band of the voice data 404 is approximately 8 kHz, which is greater than the 4 kHz frequency band of audio signal 411 in accordance with the example.

A double talk detector 406 receives the voice data 404. The voice data 404 includes the audio produced by speaker 401 and the near end user speaking into the microphone 402. Since the bandwidth of the audio signal 411 is limited and less than the bandwidth of the voice data 404, double talk detector 406 may determine if any frequency components in a frequency band equal to the difference between the limited frequency band of audio signal 411 and the entire frequency band of voice data 404 is present. If a frequency component is present, its presence is contributed to the near end person speaking into the microphone. Therefore, in accordance with various aspects of the invention, a double-talk condition of the near end user and audio from the speaker is detected.

Referring to FIG. 6, a graphical representation of the different frequency bands is shown. The frequency response of the audio signal 411 may be shown by graph 501. The frequency response of the voice data 404 is shown by the graph 502. The frequency band 503 is the difference between the frequency response 501 and 502. If any signal energy is present in the frequency band 503, the signal energy is contributed to the near end user speaking into the microphone 402. The signal energy may be contributed to any frequency component in the frequency band 503 or to any combination of frequency components or all the components. Double talk detector 406 may use a band pass filter to isolate the frequency components in the frequency band 503. A comaparator may be used to compare an accumulated energy to a threshold for detecting whether any noticeable energy is present in the frequency band 503. If the detected energy is above the threshold, a double talk condition may be present. The threshold may be adjusted for different conditions. For example, the conditions in a crowded noisy place, an empty room and in a car may be different. Therefore, the threshold may also be different for different conditions. A configuration file loaded in the system may change the threshold from time to time.

An anti aliasing filter 405, usually a low pass filter, followed by a sub-sampling block may be used to down-sample the voice data 404 by a factor of 2. The down sampling may be performed at different factors also. For example, if a down sampling factor of 3 is used with an ADC 403 sampling of 24 KHz, the frequency band 503 may be from 4 KHz to 12 KHz accordingly. An adaptive filter 420 produces a replica of acoustic echo signal e1(n) to be subtracted from the filtered voice data in an adder 407. The coefficients of the adaptive filter 420 may be changing based on the signal 409, representing d(n). The operation of adaptive filter 420 may be controlled by a control signal 421 in accordance with various embodiments of the invention. Control signal 421 is produced based on whether double talk detector 406 detects a double talk condition. If a double talk condition is detected, control signal 421 holds the coefficients of the adaptive filter 420 to reproduce the echo signal e1(n) in accordance with various aspects of the invention. The coefficients of the adaptive filter 420 may be held constant at the time of the double talk detection. In a double talk condition, adaptive filter 420 may not change the coefficients. When the double talk condition is not present, control signal 421 allows the adaptive filter 420 to operate. The coefficients of the adaptive filter 420 may be adjusted. The echo signal e1(n), whether the coefficients are being held constant or changing, is used in the summer 407. The summer 407 produces the processed voice data 409. The processed voice data is used by unit 410 as a response to a far end user or a voice response to a voice prompt. In case of using a VR system, the unit 410 may use the processed voice data 409 for VR operation. Therefore, an improved echo cancellation system is provided in accordance with various aspects of the invention. The improved system allows the far end user to hear the near end user more clearly without presence of an echo and diminishing the effect of the voice prompt in the received voice data. The received voice data may be processed by the VR system more effectively when the undesired components have been removed.

The previous description of the preferred embodiments is provided to enable any person skilled in the art to make or use the present invention. The various modifications to these embodiments will be readily apparent to those skilled in the art, and the generic principles defined herein may be applied to other embodiments without the use of the inventive faculty.

What is claimed is:

1. A system for echo cancellation, comprising:
a double talk detector configured for detecting a double talk condition, wherein said double talk detector operates to detect said double talk condition by monitoring voice energy in a first frequency band;
an adaptive filter configured for producing an echo signal based on a set of coefficients, wherein said adaptive filter holds said set of coefficients constant when said double talk detector detects said double talk condition;
means for inputting audible signals in a second frequency band, wherein said second frequency band is wider and overlaps said first frequency band and said echo signal is used to cancel echo in said input signal.

2. The system as recited in claim 1 further comprising:
a loud speaker for playing voice data in a third frequency band essentially equal to a difference of said first and second frequency bands, wherein said first and third frequency bands essentially makeup said second frequency band.

3. The system as recited in claim 1 further comprising:
a control signal for controlling said adaptive filter, to hold said set of coefficients constant, based on whether said double talk detector detects said double talk condition.

4. The system as recited in claim 1, wherein said means for inputting includes a microphone system, further comprising:
an analog to digital converter configured for producing voice data, based on said audible signals picked up by said microphone, in said second frequency band, wherein said double talk detector operates on said voice data to detect said double talk condition.

5. The system as recited in claim 2 further comprising:
an analog to digital converter configured for producing an audio signal within said third frequency band, wherein loud speaker is configured for playing said audio signal.

6. A method for canceling echo, comprising:
monitoring voice energy in a first frequency band for detecting a double talk condition;
producing an echo signal based on a set of coefficients, wherein said set of coefficients are held constant when said double talk condition is detected;
inputting audible signals in a second frequency band, wherein said second frequency band is wider and overlaps said first frequency band and said echo signal is for canceling echo in said input signal.

7. The method as recited in claim 6 further comprising:
playing voice data in a third frequency band essentially equal to a difference of said first and second frequency bands, wherein said first and third frequency bands essentially makeup said second frequency band.

8. The method as recited in claim 6 further comprising:
producing a control signal for holding said set of coefficients constant, based on whether said double talk condition is detected.

9. The method as recited in claim 6 further comprising:
producing voice data based on said audible signals in said second frequency band, wherein detection of said double talk condition is based on said voice data.

10. The method as recited in claim 7 further comprising:
producing an audio signal within said third frequency band for said playing voice data.

11. A microprocessor system for echo cancellation, comprising:
means for a double talk detector configured for detecting a double talk condition, wherein said double talk detector operates to detect said double talk condition by monitoring voice energy in a first frequency band;
means for an adaptive filter configured for producing an echo signal based on a set of coefficients, wherein said adaptive filter holds said set of coefficients constant when said double talk detector detects said double talk condition;
means for inputting audible signals in a second frequency band, wherein said second frequency band is wider and overlaps said first frequency band and said echo signal is used to cancel echo in said input signal.

12. The microprocessor as recited in claim 11 further comprising:
means for a loud speaker for playing voice data in a third frequency band essentially equal to a difference of said first and second frequency bands, wherein said first and third frequency bands essentially makeup said second frequency band.

13. The microprocessor as recited in claim 11 further comprising:
means for a control signal for controlling said adaptive filter, to hold said set of coefficients constant, based on whether said double talk detector detects said double talk condition.

14. The microprocessor as recited in claim 11 further comprising:
means for an analog to digital converter configured for producing voice data, based on said audible signals picked up by a microphone of said means for inputting, in said second frequency band, wherein said double talk detector operates on said voice data to detect said double talk condition.

15. The microprocessor as recited in claim 12 further comprising:
means for an analog to digital converter configured for producing an audio signal within said third frequency band, wherein loud speaker is configured for playing said audio signal.

16. A device incorporating an echo cancellation system for canceling echo, comprising:
a control system for monitoring voice energy in a first frequency band for detecting a double talk condition and for producing an echo signal based on a set of coefficients, wherein said set of coefficients are held constant when said double talk condition is detected;
a microphone system for inputting audible signals in a second frequency band, wherein said second frequency band is wider and overlaps said first frequency band and said echo signal is for canceling echo in said input signal.

17. The device as recited in claim 16 further comprising:
a speaker system for playing voice data in a third frequency band essentially equal to a difference of said first and second frequency bands, wherein said first and third frequency bands essentially makeup said second frequency band.

18. The device as recited in claim 16 wherein said control system is configured for producing a control signal for holding said set of coefficients constant, based on whether said double talk condition is detected.

19. The device as recited in claim 16 wherein said microphone system is configured for producing voice data based on said audible signals in said second frequency band, wherein detection of said double talk condition is based on said voice data.

20. The device as recited in claim 17 wherein said speaker system is configured for producing an audio signal within said third frequency band for said playing voice data.
